(19) United States
(12) Patent Application Publication
(10) Pub. No.: US 2026/0346989 A1
(43) Pub. Date: Nov. 5, 2026

(54) INFINITE ADJUSTMENT ROTARY ARMREST

(71) Applicant: B/E Aerospace, Inc., Winston-Salem, NC (US)

(72) Inventors: Michael Bormann, Kernersville, NC (US); Bobby Lawson, Walnut Cove, NC (US); Troy Blackburn, Elkin, NC (US)

(21) Appl. No.: 19/657,459

(22) Filed: Apr. 24, 2026

Related U.S. Application Data
(60) Provisional application No. 63/798,254, filed on May 1, 2025.

(51) Int. Cl. B64D 11/06

(52) U.S. Cl. CPC B64D 11/0644

(57) ABSTRACT

An aircraft armrest is configured to translate up and down, and rotate forward when translated. Lever arms that control the rotation of the armrest are connected to a rotation gear. The movement of the rotation gear, and thereby the lever arms, is controlled via a gear stop lever. The gear stop lever is controlled by the user via an armrest release button. The rotation gear and gear stop lever define granular position stops so that the user can stop the rotation of the armrest at any of a large number of positions depending on the needs of the user.

### PRIORITY

The present application claims the benefit under , which is incorporated herein by reference.

### BACKGROUND

Conventional adjustable armrests, including armrests used in passenger seating environments such as aircraft seating, often provide only limited ranges of motion and limited positioning flexibility. In many implementations, an armrest may be movable between an upright position and a lowered position, or between a deployed position and a stowed position, but may not provide fine positional adjustment throughout a range of intermediate orientations. In other arrangements, rotational motion may be provided, but the available adjustment may be constrained by the underlying support mechanism or by the type of position-holding structure employed. As a result, existing armrest arrangements may be poorly suited for applications in which user comfort, spatial efficiency, or adaptable support surfaces are desired.

Some adjustable armrest systems and other repositionable support members have employed force-based retention arrangements, such as gas spring mechanisms or other friction-dependent structures, to permit movement and selective holding of a movable member. While such arrangements can provide a degree of adjustability, they may be subject to practical drawbacks. For example, force-based systems may be sensitive to wear, temperature, manufacturing variation, or user strength, and may not always provide a sufficiently predictable or ergonomic adjustment experience across a full range of users.

In seating environments in which available space changes as the seat transitions between modes, additional challenges may arise. For example, when a seat transitions toward a reclined or bed configuration, it may be desirable for an armrest to move in a manner that better occupies adjacent space and provides supplemental support to the occupant. However, conventional armrest mechanisms may not permit a movable armrest to be repositioned in a controlled and highly adjustable manner while also accommodating the packaging constraints of the seat structure. It would be advantageous to provide an armrest capable of translating and rotating so as to improve comfort and support in multiple use conditions.

Accordingly, there remains a need for improved adjustable support mechanisms, including armrest mechanisms, that can provide controlled rotational repositioning through a plurality of selectively retainable positions, preferably with fine positional resolution, without relying exclusively on force-based retention structures such as gas springs. There is further a need for such mechanisms to be compact, reliable, and suitable for integration into movable seating structures, including arrangements in which a support member may translate and rotate relative to an associated seat or frame.

### SUMMARY

The present disclosure relates generally to adjustable support structures, and more particularly to mechanisms for selectively positioning a pivot arm, such as an armrest, through a plurality of controlled positions. In certain embodiments, the disclosure provides a positioning system that enables a user to reposition a movable support member with a high degree of adjustability while maintaining reliable and repeatable positional retention.

In one aspect, a positioning mechanism is provided for a pivot arm. The positioning mechanism includes a gear element operatively coupled to the pivot arm and having a plurality of teeth corresponding to a plurality of discrete angular positions. A stop element is selectively engageable with the gear element to inhibit rotation of the pivot arm when engaged with one or more of the teeth. A biasing element urges the stop element toward engagement with the gear element. A user-actuated release mechanism is operatively coupled to the stop element and is configured to selectively disengage the stop element from the gear element to permit rotation of the pivot arm. Upon release of the user-actuated mechanism, the stop element is returned into engagement with the gear element to retain the pivot arm at a selected position.

In certain embodiments, the spacing of the teeth of the gear element is selected such that the pivot arm may be positioned at a large number of closely spaced angular positions, thereby providing a degree of adjustability that approximates continuous positioning while maintaining the advantages of discrete mechanical engagement. In this manner, the positioning mechanism may provide improved reliability and user control as compared to force-based retention systems.

In another aspect, the positioning mechanism may be incorporated into an adjustable armrest assembly. The armrest assembly may include a support structure and an armrest coupled to the support structure for rotational movement. The positioning mechanism may be integrated with the armrest such that the armrest is selectively positionable through a range of rotational orientations. In certain embodiments, the armrest assembly may further include a translation mechanism configured to permit vertical movement of the armrest relative to the support structure, such that the armrest may both translate and rotate during use.

In some implementations, the armrest may be coupled to the support structure through one or more linkage elements that guide movement of the armrest during rotation. Such linkage elements may be configured to produce a controlled extension of the armrest as it rotates, thereby enabling the armrest to occupy an extended position relative to the support structure. In certain seating applications, including aircraft seating, this arrangement may allow the armrest to provide supplemental support when the seat is in a reclined or bed configuration.

In further embodiments, the user-actuated release mechanism may be configured to control both the positioning mechanism and other aspects of armrest movement, such that a single user input selectively enables repositioning of the armrest. The positioning mechanism described herein may also be applied to other movable structures in which controlled rotational positioning is desired.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1A shows a side view of an armrest according to an exemplary embodiment in a raised, non-extended configuration with internal components obscured;

FIG. 1B shows a side view of the armrest of FIG. 1A with internal components visible;

FIG. 2A shows a side view of an armrest according to an exemplary embodiment in an extended configuration;

FIG. 2B shows a side view of the armrest of FIG. 2A with internal components visible;

FIG. 3 shows a detail side view of an armrest according to an exemplary embodiment in a raised, non-extended configuration, including a user-actuated release;

FIG. 4 shows a detail view of a retention mechanism according to an exemplary embodiment in an engaged condition;

FIG. 5A shows a detail view of a retention mechanism according to an exemplary embodiment in an engaged condition;

FIG. 5B shows a detail view of the retention mechanism of FIG. 5A in a disengaged condition;

FIG. 6A shows a perspective view of an armrest according to an exemplary embodiment in a lowered, non-extended configuration;

FIG. 6B shows a perspective view of the armrest of FIG. 6A in a raised and extended configuration.

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to an aircraft armrest configured to translate up and down, and rotate forward when translated. Lever arms that control the rotation of the armrest are connected to a rotation gear. The movement of the rotation gear, and thereby the lever arms, is controlled via a gear stop lever. The gear stop lever is controlled by the user via an armrest release button. The rotation gear and gear stop lever define granular position stops so that the user can stop the rotation of the armrest at any of a large number of positions depending on the needs of the user.

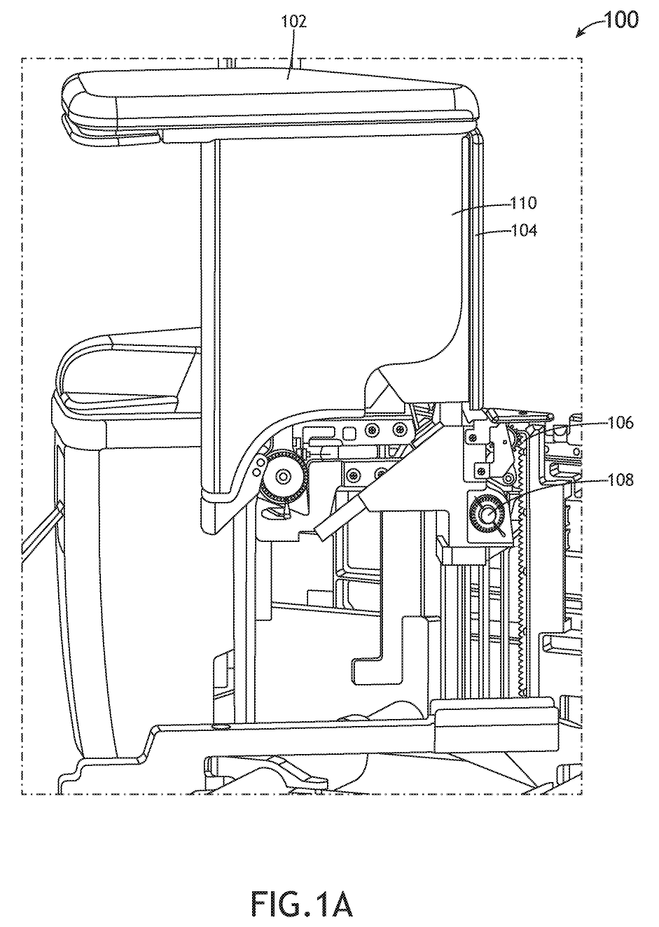

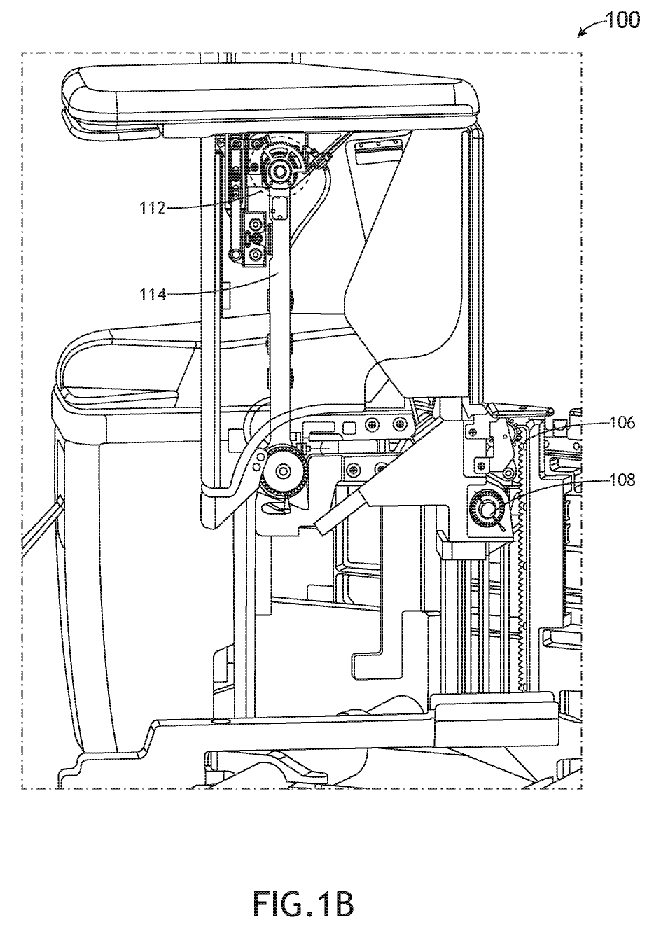

Referring now to FIGS. 1A and 1B, an armrest assembly, including an apparatus for selectively positioning the armrest100, is illustrated in a raised, non-extended configuration. In the illustrated embodiment, the armrest 100 is shown positioned above a lower stowed position, but prior to forward rotational extension.

FIG. 1A depicts the armrest 100 with an outer cowling 110 in place, such that internal components of the armrest assembly are substantially obscured from view. The cowling 110 may be formed as a structural or semi-structural housing configured to enclose and protect internal mechanisms of the armrest 100, while also providing a finished exterior surface suitable for a passenger environment. It will be appreciated that the cowling 110 may be omitted, partially transparent, or otherwise modified in alternative embodiments.

FIG. 1B illustrates the armrest 100 with the cowling 110 rendered transparent to reveal internal components. As shown, the armrest 100 is supported by a translation mechanism configured to raise and lower the armrest relative to an associated support structure (not shown). In the illustrated embodiment, the translation mechanism includes a rack 106 and a pinion 108 operatively engaged with the rack 106. Rotation of the pinion 108 relative to the rack 106 results in vertical displacement of the armrest 100. In certain embodiments, the translation mechanism may further include a damping element, such as a rotary damper, to control the rate of movement and inhibit uncontrolled descent of the armrest 100.

Although the illustrated embodiment employs a rack and pinion arrangement for vertical translation, it will be appreciated that other translation mechanisms may be employed. Such mechanisms may include lead screw systems, sliding track assemblies, cam-driven linkages, or other guided motion systems configured to raise and lower the armrest relative to a support structure.

In certain embodiments, the translation mechanism may include one or more damping elements configured to control the rate of vertical movement. Such damping elements may include rotary dampers, linear dampers, viscous damping devices, or friction-based elements configured to dissipate energy during motion. These damping elements may be particularly advantageous in preventing rapid or uncontrolled descent of the armrest, thereby improving safety and perceived quality of operation.

The armrest 100 includes a forward cushion 102 and a rear cushion 104. In the raised, non-extended configuration shown in FIGS. 1A and 1B, the forward cushion 102 is oriented in a generally horizontal position suitable for supporting a user’s arm. The rear cushion 104, in contrast, is oriented in a generally vertical position. As will be described in greater detail with respect to subsequent figures, the rear cushion 104 is configured to rotate relative to the forward cushion 102 during extension of the armrest 100, such that both cushions may become generally coplanar in an extended configuration.

Portions of a positioning and extension mechanism are also visible in FIG. 1B. In the illustrated embodiment, the armrest 100 includes a retention mechanism 112 operatively associated with a rotatable element of the armrest assembly. The retention mechanism 112 may include, for example, a gear-based indexing structure configured to selectively retain the armrest 100 at one of a plurality of angular positions during rotation. A pivot arm 114 is coupled to the armrest structure and is configured to guide rotational movement of at least a portion of the armrest 100. The pivot arm 114 may form part of a linkage system that controls the path of motion of the armrest during extension.

In the configuration shown in FIGS. 1A and 1B, the retention mechanism 112 is engaged such that rotational movement of the armrest 100 is inhibited. Upon actuation of a release mechanism (not shown in FIGS. 1A and 1B), the retention mechanism 112 may be disengaged to permit rotation of the armrest 100 about a pivot axis defined at least in part by the pivot arm 114 and associated linkages. When the release mechanism is no longer actuated, the retention mechanism 112 may re-engage to secure the armrest 100 at a selected rotational position.

It will be appreciated that while the illustrated embodiment employs a rack 106 and pinion 108 for vertical translation and a gear-based retention mechanism 112 for rotational positioning, alternative mechanisms may be employed in other embodiments without departing from the scope of the present disclosure.

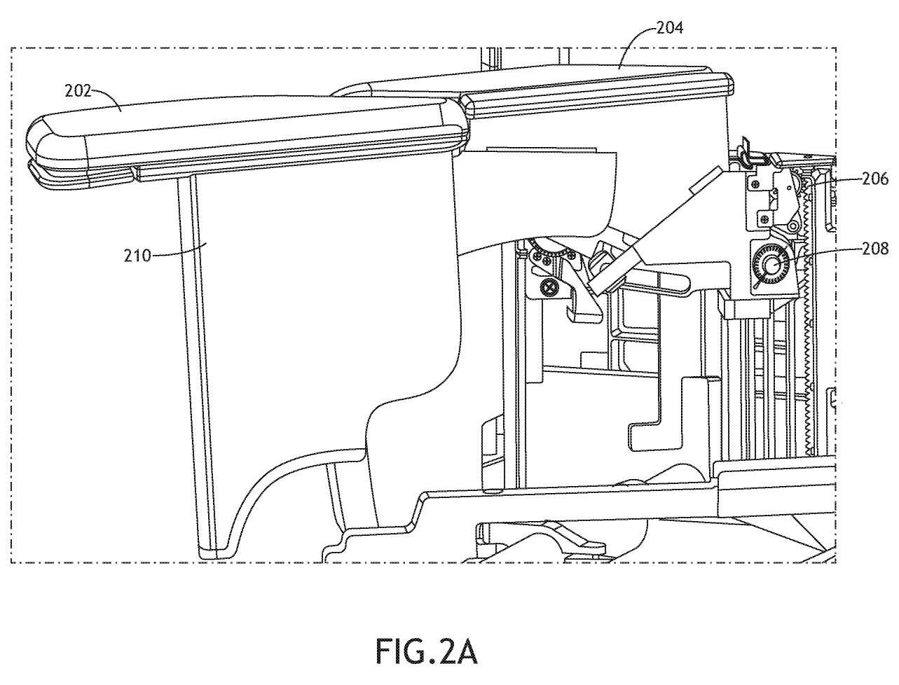

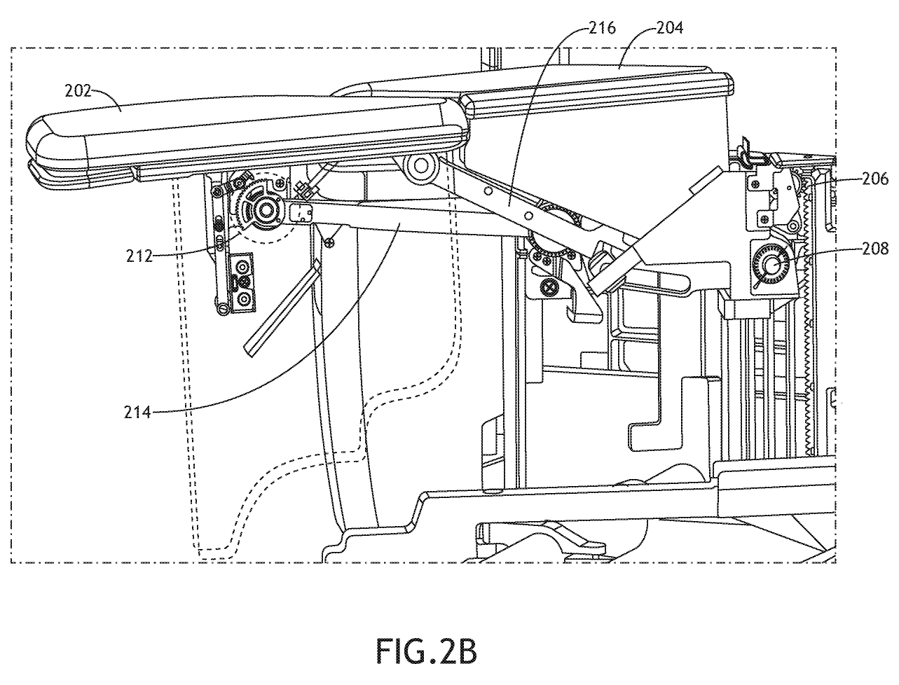

Referring now to FIGS. 2A and 2B, an armrest assembly is illustrated in an extended configuration. In contrast to the raised, non-extended configuration described with respect to FIGS. 1A and 1B, the armrest 200 in FIGS. 2A and 2B has been rotated forward and extended to provide an enlarged support surface.

FIG. 2A illustrates the armrest 200 in the extended configuration with external surfaces visible, while FIG. 2B illustrates the same configuration with internal components visible. As shown, the armrest 200 includes a forward cushion 202 and a rear cushion 204. In the extended configuration, the forward cushion 202 and the rear cushion 204 are arranged such that their upper surfaces are substantially aligned, thereby forming a generally continuous support surface. This configuration may be particularly advantageous in seating arrangements in which the armrest 200 is intended to supplement a support surface, such as in a reclined or bed configuration of a seat.

As best seen in FIG. 2B, the armrest 200 is supported by a linkage system that guides movement of the armrest during extension. In the illustrated embodiment, the linkage system includes a pivot arm 214 and an armature 216. The pivot arm 214 is coupled to the armrest structure and defines at least part of the rotational path of the armrest 200 as it moves from the raised position to the extended position. The armature 216 is operatively coupled to the pivot arm 214 and to the forward cushion 202 such that coordinated movement of the pivot arm 214 and the armature 216 maintains the forward cushion 202 in a generally horizontal orientation throughout the rotational movement.

In particular, as the armrest 200 rotates forward, the pivot arm 214 guides the overall motion of the armrest, while the armature 216 constrains the orientation of the forward cushion 202 relative to the support structure. This coordinated motion may be achieved through a multi-link arrangement, such as a four-bar linkage or a functionally equivalent linkage configuration, in which relative movement of the links produces both forward extension and controlled angular orientation of the armrest components. As a result, the forward cushion 202 remains substantially horizontal even as the armrest 200 undergoes rotational displacement.

While the illustrated embodiment includes a pivot arm 214 and an armature 216, it will be appreciated that these elements may form part of a broader linkage system configured to control both the path of motion and the angular orientation of one or more portions of the armrest. In some embodiments, the linkage system may include a multi-link arrangement, such as a four-bar linkage or functionally equivalent mechanism, configured to maintain a support surface in a substantially constant orientation during extension. Other linkage configurations, including cam-based or guided track systems, may be employed to achieve similar kinematic behavior.

The rear cushion 204 is coupled to the forward cushion 202 and is configured to rotate relative thereto during extension. In the extended configuration, the rear cushion 204 transitions from a generally vertical orientation (as shown in FIGS. 1A and 1B) to a generally horizontal orientation aligned with the forward cushion 202. This coordinated movement contributes to the formation of the continuous support surface described above.

Also visible in FIG. 2B is a retention mechanism 212 associated with the rotational positioning of the armrest 200. The retention mechanism 212 may include a gear element and a selectively engageable stop element, as described elsewhere herein, and is configured to retain the armrest 200 at one of a plurality of angular positions. In the extended configuration shown, the retention mechanism 212 is engaged to maintain the armrest 200 in the extended position. Actuation of a release mechanism (not shown in FIGS. 2A and 2B) may disengage the retention mechanism 212 to permit movement of the armrest 200 back toward the raised or stowed configuration.

As illustrated, the various components of the linkage system and the retention mechanism 212 are integrated within the armrest structure and move together during operation. It will be appreciated that the particular arrangement of the pivot arm 214, the armature 216, and associated linkages may vary in alternative embodiments while still providing controlled extension and orientation of the armrest 200.

It will further be appreciated that although FIGS. 2A and 2B illustrate a specific configuration in which the forward cushion 202 is maintained in a generally horizontal orientation during extension, other embodiments may employ alternative linkage geometries or constraints to achieve similar or different motion profiles, depending on the intended application.

In some embodiments, the relative positioning of the forward cushion 202 and the rear cushion 204 in the extended configuration may define a substantially continuous support surface. Such a configuration may reduce or eliminate discontinuities between adjacent support regions, thereby improving user comfort, particularly in configurations in which the armrest supplements a reclining or bed-like support surface. It will be appreciated that the degree of alignment between the forward cushion 202 and the rear cushion 204 may vary depending on design considerations, and need not be perfectly coplanar in all embodiments.

The retention mechanism 212 may further permit selective positioning of the armrest 200 at a plurality of intermediate positions between a non-extended configuration and a fully extended configuration. In this manner, a user may adjust the armrest to a desired position based on comfort or functional requirements, rather than being limited to discrete stowed and fully extended positions.

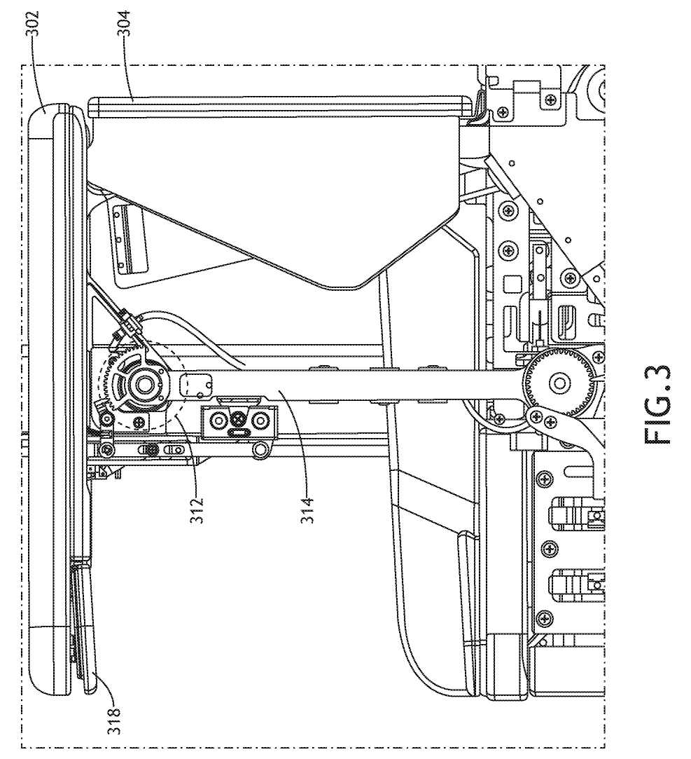

Referring now to FIG. 3, a detailed view of an armrest assembly is illustrated in a raised, non-extended configuration. In this configuration, the armrest 300 is elevated relative to an associated support structure but has not yet been rotated forward into an extended position.

As shown, the armrest 300 includes a forward cushion 302 and a rear cushion 304. In the illustrated configuration, the forward cushion 302 is oriented in a generally horizontal position suitable for supporting a user’s arm, while the rear cushion 304 is oriented in a generally vertical position. The relative orientation of the forward cushion 302 and the rear cushion 304 in this configuration corresponds to the pre-extension state described above with respect to FIGS. 1A and 1B.

Also visible in FIG. 3 is a pivot arm 314, which is operatively coupled to the armrest structure and configured to guide rotational movement of the armrest 300 during extension. The pivot arm 314 may be connected between a fixed or semi-fixed portion of the support structure and a movable portion of the armrest 300, and may define at least part of the kinematic path followed by the armrest as it transitions between configurations. In certain embodiments, the pivot arm 314 may form part of a multi-link arrangement configured to produce coordinated motion of the armrest components, as described elsewhere herein.

A retention mechanism 312 is further provided and is associated with the rotational positioning of the armrest 300. In the illustrated embodiment, the retention mechanism 312 is disposed within the armrest structure and is operatively coupled to a rotatable portion of the armrest 300. The retention mechanism 312 may include a gear element and a stop element selectively engageable with the gear element to inhibit rotation of the armrest 300 when engaged. In the configuration shown in FIG. 3, the retention mechanism 312 is engaged, thereby maintaining the armrest 300 in the raised, non-extended position.

A release button 318 is disposed on an inferior surface of the armrest 300, beneath the forward cushion 302. The release button 318 is accessible to a user and is configured to actuate a release mechanism associated with the retention mechanism 312. In particular, actuation of the release button 318 may cause displacement of a linkage (not shown in FIG. 3) that disengages the stop element from the gear element of the retention mechanism 312, thereby permitting rotational movement of the armrest 300. Upon release of the release button 318, the retention mechanism 312 may re-engage to secure the armrest 300 at a selected angular position.

In this manner, the release button 318 provides a user interface for selectively enabling repositioning of the armrest 300 while allowing the retention mechanism 312 to maintain the armrest in a stable position when the release button is not actuated. It will be appreciated that the location and configuration of the release button 318 may vary in alternative embodiments, and that other user-actuated elements may be employed to achieve similar functionality.

While the release button 318 is illustrated as being disposed on an inferior surface of the armrest beneath the forward cushion 302, it will be appreciated that the release interface may be positioned at other locations accessible to a user. For example, the release interface may be located on a lateral surface, an upper surface, or integrated into another user interface element associated with the armrest or seat assembly.

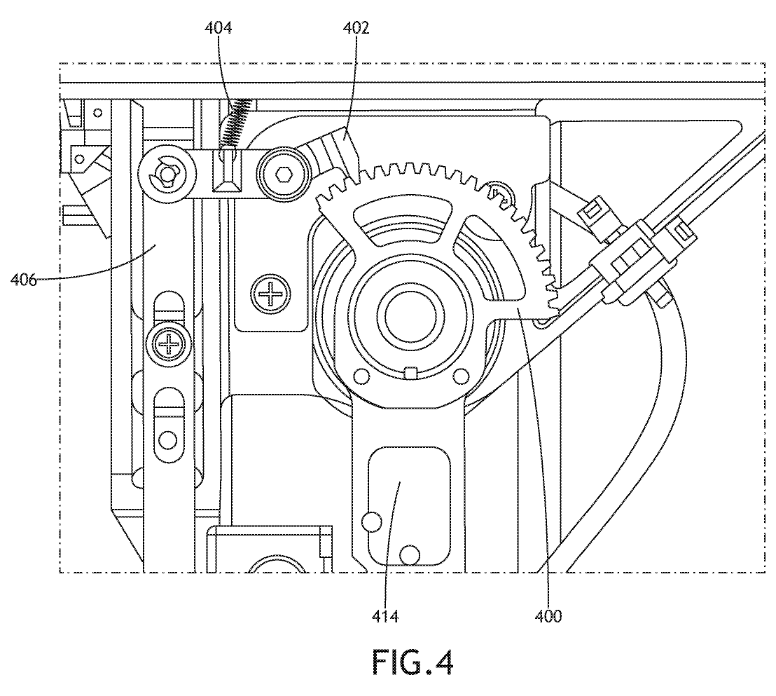

Referring now to FIG. 4, a detailed view of a retention mechanism is illustrated. The retention mechanism is configured to selectively inhibit and permit rotational movement of a movable portion of an armrest assembly, as described herein.

The retention mechanism includes a toothed gear 400, which in certain embodiments may be implemented as a sector gear or sprocket having a plurality of teeth distributed along at least a portion of its circumference. The teeth need not extend entirely around the gear 400, and may instead be provided only along a selected angular range corresponding to a range of rotational motion of the associated armrest. The gear 400 is operatively coupled to, and in the illustrated embodiment affixed to, a pivot arm 414 such that rotation of the pivot arm 414 causes corresponding rotation of the gear 400. In this manner, angular movement of the armrest during extension is directly associated with rotation of the gear 400.

A stop lever 402 is provided and is positioned to selectively engage the teeth of the gear 400. In an engaged condition, the stop lever 402 interfaces with one or more teeth of the gear 400 to inhibit rotation of the gear 400 and, correspondingly, rotation of the pivot arm 414 and associated armrest structure. The stop lever 402 may be mounted for pivoting movement relative to a support structure and may include a tooth-engaging portion configured to seat between adjacent teeth of the gear 400.

A biasing element 404 is operatively coupled to the stop lever 402 and is configured to bias the stop lever 402 toward engagement with the gear 400. The biasing element 404 may include, for example, a spring element arranged to apply a restoring force to the stop lever 402 such that, in the absence of an opposing force, the stop lever 402 is biased into engagement with the teeth of the gear 400.

A latch linkage 406 is operatively coupled to the stop lever 402 and is configured to selectively move the stop lever 402 out of engagement with the gear 400. The latch linkage 406 is, in turn, actuated by a user-operated release mechanism (not shown in FIG. 4). In the illustrated embodiment, the latch linkage 406 is movable generally in a vertical direction. Upward or downward movement of the latch linkage 406, depending on the configuration, causes corresponding displacement of the stop lever 402 to a disengaged position in which the stop lever 402 is spaced from the teeth of the gear 400.

In operation, when the latch linkage 406 is not actuated, the biasing element 404 maintains the stop lever 402 in engagement with the gear 400, thereby preventing rotation of the pivot arm 414. When the user actuates the release mechanism, the latch linkage 406 is displaced so as to move the stop lever 402 away from the gear 400, overcoming the biasing force of the biasing element 404. In this disengaged condition, the gear 400 is free to rotate, allowing the pivot arm 414 and associated armrest structure to move. Upon release of the user-operated control, the latch linkage 406 returns toward its original position, permitting the biasing element 404 to re-engage the stop lever 402 with the gear 400, thereby retaining the armrest at a selected angular position.

Because the plurality of teeth of the gear 400 define a corresponding plurality of discrete engagement positions for the stop lever 402, the retention mechanism enables the armrest to be selectively retained at a plurality of angular positions. By selecting an appropriate spacing and number of teeth, the angular increments between adjacent positions may be made relatively small, thereby providing a degree of adjustability that approximates continuous positioning while maintaining the advantages of positive mechanical engagement.

In some embodiments, the rotational system associated with the gear 400 and pivot arm 414 may further include one or more damping elements configured to control rotational movement of the armrest. Such damping elements may include rotary dampers, friction interfaces, or fluid-based resistance mechanisms configured to smooth motion, reduce noise, and inhibit abrupt transitions between angular positions. The inclusion of such damping may provide a more controlled and refined user experience, particularly during extension and retraction of the armrest.

It will be appreciated that while the illustrated embodiment employs a pivotable stop lever 402 and a linearly movable latch linkage 406, other configurations of stop elements and actuation linkages may be employed in alternative embodiments. Likewise, the biasing element 404 may take various forms and may be arranged in different configurations to achieve the desired engagement behavior.

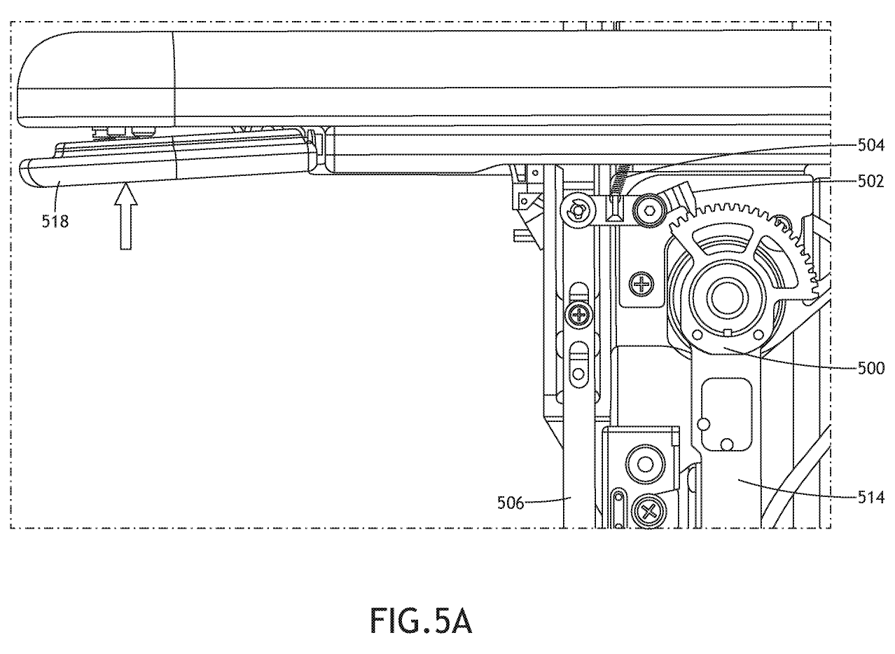

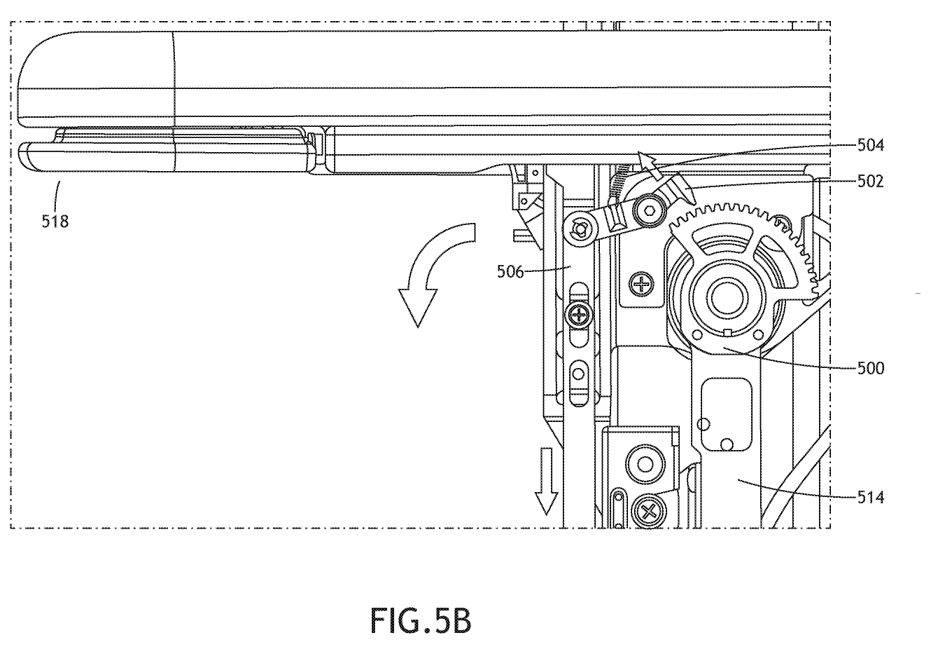

Referring now to FIGS. 5A and 5B, a retention mechanism is illustrated in two operational states, together with a user-actuated release interface. The retention mechanism may be substantially similar in structure and operation to the retention mechanism described with respect to FIG. 4, except as otherwise noted.

As shown in FIG. 5A, the retention mechanism is in an engaged condition. The retention mechanism includes a toothed gear 500, which may be implemented as a sector gear or sprocket having a plurality of teeth distributed along at least a portion of its circumference. The gear 500 is operatively coupled to a pivot arm (corresponding to the pivot arm 414 in FIG. 4) such that rotation of the pivot arm produces corresponding rotation of the gear 500.

A stop lever 502 is positioned to selectively engage the teeth of the gear 500. In the engaged condition shown in FIG. 5A, the stop lever 502 interfaces with one or more teeth of the gear 500 to inhibit rotation of the gear 500 and thereby prevent movement of the associated armrest. The stop lever 502 may be pivotably mounted and may include a tooth-engaging portion configured to seat between adjacent teeth of the gear 500.

A biasing element 504 is operatively coupled to the stop lever 502 and is configured to bias the stop lever 502 toward engagement with the gear 500. In the absence of an opposing force, the biasing element 504 maintains the stop lever 502 in the engaged position, thereby securing the armrest against rotational movement.

A latch linkage 506 is operatively coupled to the stop lever 502 and is configured to selectively move the stop lever 502 out of engagement with the gear 500. A user-actuated release button 518 is further provided and is operatively coupled to the latch linkage 506. In the condition shown in FIG. 5A, the release button 518 is not actuated, and the latch linkage 506 is positioned such that the stop lever 502 remains engaged with the gear 500 under the influence of the biasing element 504.

FIG. 5B illustrates the retention mechanism in a disengaged condition resulting from actuation of the release button 518. As shown, depression of the release button 518 causes displacement of the latch linkage 506, which in turn moves the stop lever 502 away from the gear 500, overcoming the biasing force of the biasing element 504. In this disengaged position, the stop lever 502 is spaced from the teeth of the gear 500, thereby permitting rotation of the gear 500 and corresponding movement of the pivot arm and associated armrest structure.

Upon release of the release button 518, the latch linkage 506 returns toward its original position, allowing the biasing element 504 to re-engage the stop lever 502 with the gear 500. In this manner, the retention mechanism automatically returns to the engaged condition to retain the armrest at a selected angular position corresponding to one of the teeth of the gear 500.

As described above, the plurality of teeth of the gear 500 define a corresponding plurality of discrete engagement positions for the stop lever 502. By providing a sufficient number of closely spaced teeth, the retention mechanism enables fine incremental positioning of the armrest, thereby approximating continuous adjustability while maintaining positive mechanical retention.

It will be appreciated that the particular configuration of the release button 518, the latch linkage 506, the stop lever 502, and the biasing element 504 may vary in alternative embodiments while still providing selective engagement and disengagement of the retention mechanism .

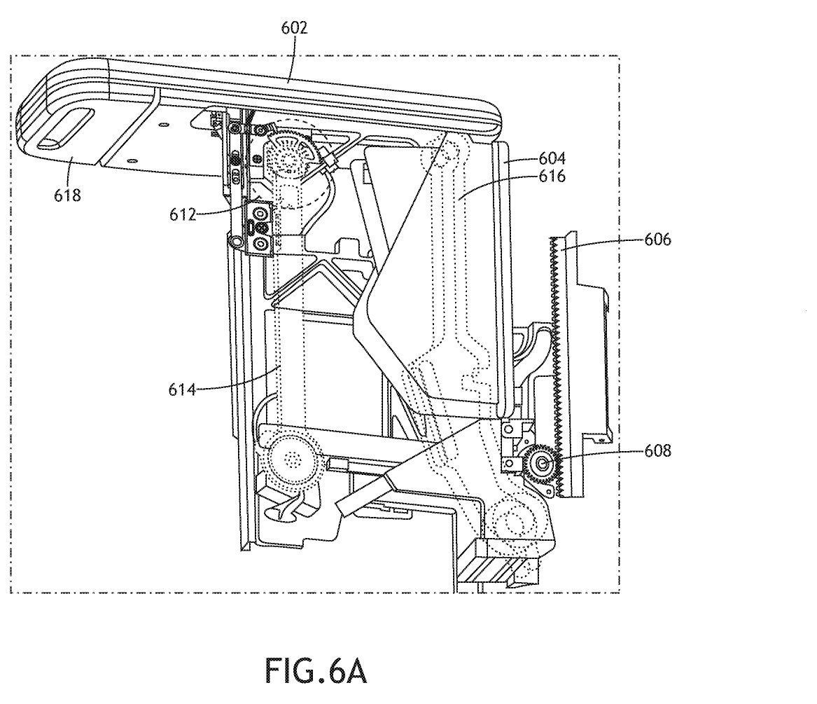

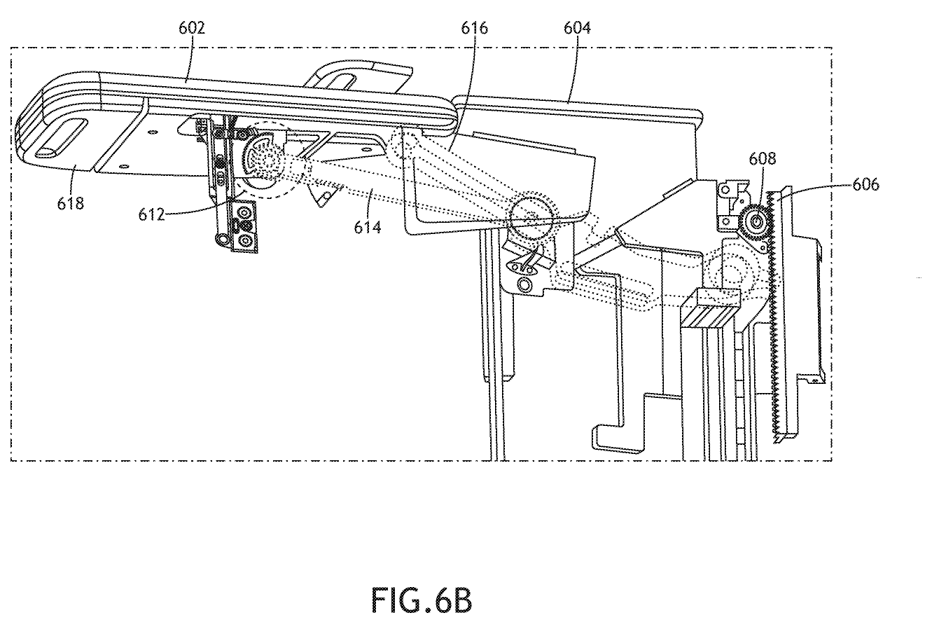

Referring now to FIGS. 6A and 6B, an armrest assembly is illustrated in a lowered configuration and a fully extended configuration, respectively. These figures collectively illustrate coordinated vertical translation and rotational extension of the armrest 600.

As shown in FIG. 6A, the armrest 600 is in a lowered, non-extended configuration. In this configuration, the armrest 600 is positioned at a lower vertical position relative to an associated support structure. A translation mechanism is provided to raise and lower the armrest 600, and in the illustrated embodiment includes a rack 606 and a pinion 608 operatively engaged with the rack 606. In FIG. 6A, the pinion 608 is positioned at a lower end of the rack 606, corresponding to the lowered position of the armrest 600.

The armrest 600 includes a forward cushion 602 and a rear cushion 604. In the lowered configuration shown in FIG. 6A, the forward cushion 602 is oriented in a generally horizontal position, while the rear cushion 604 is oriented in a generally vertical position. A pivot arm 614 and an armature 616 are operatively coupled to the armrest structure and are shown in a generally vertical and substantially parallel arrangement in this configuration.

A retention mechanism 612 is associated with the rotational positioning of the armrest 600 and is configured to inhibit rotation of the armrest 600 when engaged. A user-actuated button 618 is provided and is operatively coupled to the retention mechanism 612 via a linkage (not shown in FIGS. 6A and 6B). In the configuration shown in FIG. 6A, the retention mechanism 612 is engaged, and the button 618 is not actuated, such that rotational movement of the armrest 600 is inhibited.

To transition from the lowered configuration of FIG. 6A to the extended configuration of FIG. 6B, the armrest 600 is first raised via the rack 606 and pinion 608 mechanism, and potentially an element to provide vertical force such as a gas piston. As the pinion 608 traverses upward along the rack 606, the armrest 600 is elevated to an upper position. In FIG. 6B, the pinion 608 is shown at or near an upper end of the rack 606, corresponding to the raised position of the armrest 600.

Upon reaching the raised position, a user may actuate the button 618 to disengage the retention mechanism 612. Disengagement of the retention mechanism 612 permits rotational movement of the armrest 600. As the armrest 600 rotates forward, the pivot arm 614 and the armature 616 move relative to one another in a coordinated manner. This movement causes the armrest 600 to extend forward relative to the support structure while controlling the orientation of the armrest components.

In particular, the coordinated motion of the pivot arm 614 and the armature 616 causes the forward cushion 602 to extend outward while maintaining a generally horizontal orientation. At the same time, the rear cushion 604 rotates from a generally vertical orientation toward a generally horizontal orientation. In the fully extended configuration shown in FIG. 6B, the forward cushion 602 and the rear cushion 604 are arranged such that their upper surfaces are substantially aligned, thereby forming a generally continuous support surface.

Once the armrest 600 reaches a desired rotational position, the user may release the button 618, allowing the retention mechanism 612 to re-engage and secure the armrest 600 in the selected position. As described elsewhere herein, the retention mechanism 612 may include a gear and stop lever arrangement that provides a plurality of discrete engagement positions corresponding to different angular orientations of the armrest 600.

It will be appreciated that while FIGS. 6A and 6B illustrate a particular sequence in which the armrest 600 is raised prior to rotation and extension, alternative embodiments may permit different sequences of movement or partial overlap of translation and rotation, depending on the configuration of the mechanism. Additionally, the specific geometry and arrangement of the pivot arm 614 and the armature 616 may vary while still providing controlled extension and orientation of the armrest 600.

Embodiments may be useful for aircraft seats that transition to a bed mode. In a bed mode, there may be some otherwise unoccupied space next to the seat. A fully rotated armrest in a forward position supplements the bed.

It may be appreciated that while certain embodiments of the present disclosure are directed toward an aircraft armrest, the mechanisms described herein )including the rotation gear, stop lever, and associated linkage systems) may be applied in other contexts in which controlled, incrementally adjustable positioning of a movable structure is desired. For example, such mechanisms may be used in seating systems, furniture, vehicular interiors, or other mechanical assemblies requiring controlled motion and positional retention.

It will be further appreciated that the relative timing of vertical translation and rotational extension of the armrest need not be strictly sequential. In some embodiments, translation and rotation may occur concurrently or in partially overlapping phases of motion. Additionally, in certain configurations, rotational movement may be permitted prior to full elevation, or elevation may occur during rotation, depending on the arrangement of the linkage and retention mechanisms.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

What is claimed is:

1. . An apparatus for selectively positioning a pivot arm, comprising:
a pivot arm configured to rotate about a pivot axis;
a gear element operatively coupled to the pivot arm and having a plurality of teeth corresponding to a plurality of discrete angular positions of the pivot arm;
a stop element movable between an engaged position and a disengaged position, the stop element being configured to engage at least one of the plurality of teeth of the gear element in the engaged position to inhibit rotation of the pivot arm;
a biasing element configured to bias the stop element toward the engaged position; and
a user-actuated release mechanism operatively coupled to the stop element and configured to move the stop element from the engaged position to the disengaged position to permit rotation of the pivot arm,
wherein, upon release of the user-actuated release mechanism, the stop element is biased into the engaged position to retain the pivot arm at a selected angular position.

2. . The apparatus of claim 1, wherein the gear element comprises a sector gear.

3. . The apparatus of claim 1, wherein the stop element comprises a pivotable lever.

4. . The apparatus of claim 1, wherein the user-actuated release mechanism comprises a button coupled to the stop element through a linkage.

5. . The apparatus of claim 4, wherein actuation of the button causes displacement of the linkage to move the stop element out of engagement with the gear element.

6. . The apparatus of claim 1, further comprising a damping element configured to resist rotational movement of the pivot arm.

7. . The apparatus of claim 6, wherein the damping element comprises a rotary damper operatively coupled to the gear element or the pivot arm.

8. . The apparatus of claim 1, wherein the plurality of teeth define angular stop increments.

9. . The apparatus of claim 1, wherein the pivot arm is supported by a structure configured to translate relative to a support.

10. . An adjustable armrest assembly, comprising:
a support structure;
an armrest coupled to the support structure for rotational movement;
a positioning mechanism configured to selectively retain the armrest at a plurality of angular positions; and
a user-actuated release mechanism configured to permit repositioning of the armrest,
wherein the positioning mechanism includes:
a gear element coupled to the armrest;
a stop element selectively engageable with the gear element; and
a biasing element configured to bias the stop element into engagement with the gear element.

11. . The adjustable armrest assembly of claim 10, wherein the armrest comprises a forward cushion and a rear cushion movable relative to one another.

12. . The adjustable armrest assembly of claim 11, wherein the rear cushion is configured to rotate relative to the forward cushion such that the cushions define a substantially continuous support surface in an extended configuration.

13. . The adjustable armrest assembly of claim 10, wherein the armrest is coupled to the support structure by a linkage system configured to guide rotational movement.

14. . The adjustable armrest assembly of claim 13, wherein the linkage system is configured to maintain at least a portion of the armrest in a generally horizontal orientation during rotation.

15. . The adjustable armrest assembly of claim 10, further comprising a translation mechanism configured to raise and lower the armrest relative to the support structure.

16. . An aircraft armrest assembly, comprising:
a support structure associated with an aircraft seat;
an armrest coupled to the support structure and movable between a stowed position and an extended position;
a translation mechanism configured to raise and lower the armrest;
a rotational positioning mechanism configured to selectively retain the armrest at a plurality of angular positions; and
a user-actuated release mechanism configured to permit repositioning of the armrest,
wherein:
the rotational positioning mechanism includes a gear element and a stop element selectively engageable with the gear element; and
the armrest is configured, in the extended position, to provide an extended support surface adjacent the aircraft seat.

17. . The aircraft armrest assembly of claim 16, wherein the translation mechanism includes a rack and pinion system.

18. . The aircraft armrest assembly of claim 16, wherein the translation mechanism includes a damping element configured to resist downward movement of the armrest.

19. . The aircraft armrest assembly of claim 16, further comprising a biasing element configured to provide a vertical force to the armrest.

20. . The aircraft armrest assembly of claim 16, wherein the armrest includes a forward cushion and a rear cushion that become substantially aligned in the extended position.
